(19) United States
(12) Patent Application Publication
(10) Pub. No.: US 2003/0035908 A1
(43) Pub. Date: Feb. 20, 2003

(54) Blocking and bracing bladder

(76) Inventor: John H. Pelto, Swansea, MA (US)

Correspondence Address: Office Of Counsel, Naval Undersea Warface Center Division, Newport, Bldg 112T, 1176 Howell Street, Newport, RI, 02841-1708, US

(21) Appl. No.: 09/932,723

(22) Filed: Aug. 20, 2001

(51) Int. Cl. B32B 1/02

(52) U.S. Cl. 428/35.2

(57) ABSTRACT

A blocking and bracing bladder component for use in package transport which includes stronger bladder wall construction with a puncture resistant material and a fluid medium impermeable material for use with military ammunition and explosives transport in maritime break bulk applications.

### STATEMENT OF GOVERNMENT INTEREST

The invention described herein may be manufactured and used by or for the Government of the United States of America for governmental purposes without the payment of any royalties thereon or therefore.

### CROSS REFERENCE OF OTHER PATENT APPLICATIONS

Not applicable.

### BACKGROUND OF THE INVENTION

(1) Field Of The Invention

The present invention relates to a blocking and bracing bladder component for use in transport applications.

(2) Description Of The Prior Art

Products being transported in shipping containers must be firmly retained in such containers, under often-severe handling conditions, to avoid damage. Current packaging techniques for such purposes include shredded newspaper, solid plastic or foam blocks, polystyrene plastic pellets and wooden frames. Such techniques are wasteful, since the materials used are generally discarded after use and are not recycled.

Simple air-filled bags have also been utilized as packing and stabilizing material. However, these simple bags frequently become punctured and useless when used under severe conditions.

These prior packing techniques are not acceptable when the product being shipped is sharp and likely to rupture prior art air-filled bags, potentially explosive, and/or unusually heavy or cumbersome. For example, current maritime break bulk shipment uses a wooden blocking and bracing structure. These structures are created uniquely for each shipment, are made from high quality fir or other equivalent lumber, require labor intensive and time consuming construction and are not reusable. In addition, these structures offer no protection to or from the military explosives and ammunition frequently transported in them.

It would be desirable to provide a reusable packaging component, which would effectively retain products in transport, while also providing additional resistance to puncture of the components themselves from both external sources as well as the product being transported.

### SUMMARY OF THE INVENTION

The present invention comprises an inflatable bladder component for use in package transport comprising an internal cavity surrounded by an exterior wall with a valve penetrating the exterior wall to allow inflating of the internal cavity. The exterior wall comprises a strong, puncture-resistant material, such as Kevlar™ brand fabric.

In the preferred embodiment, the exterior wall comprises three layers: an outer layer, a middle layer, and an inner layer. The outer and inner layers are made of neoprene to add airtight integrity and abrasion resistance. The middle layer is made of woven Kevlar™ brand fabric or other suitable material for strength and shape. The preferred valve is a Schrader air fitting for inflation and deflation.

### BRIEF DESCRIPTION OF THE DRAWINGS

These and other features and advantages of the present invention will be better understood in view of the following description of the invention taken together with the drawings wherein:

FIG. 1 is a perspective view of the present invention;

FIG. 2 is a cross-sectional view of the exterior wall of the present invention; and

FIG. 3 is a representation of one of the uses of a device of subject inventive concept for transporting an explosive material.

### DESCRIPTION OF THE PREFERRED EMBODIMENT

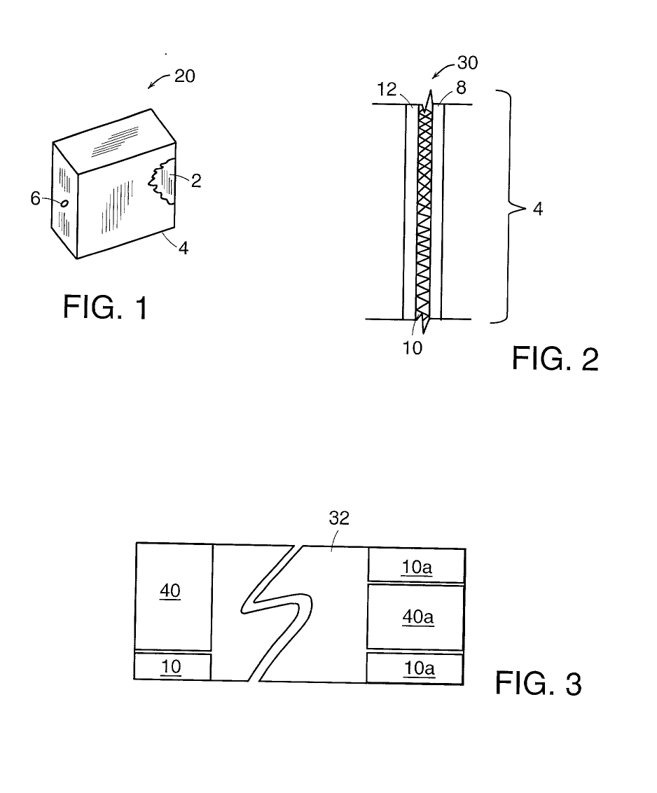

The inflatable bladder 20, FIG. 1, in accordance with the present invention is adapted for use in package transport, although such use is not a limitation of the structure of the present inflatable bladder. The inflatable bladder 10 comprises an internal cavity 2 surrounded by a multi-layered exterior wall 4, which is penetrated by a valve 6, such as a Schrader air valve to allow inflation of the cavity 2.

The multi-layer exterior wall 4 comprises at least a one layer of a puncture-resistant material, such as Kevlar™ brand fabric. In the preferred embodiment, the multi-layered exterior wall 4 is comprised of a three-layered structure 30, FIG. 2, including an outer layer 8, a middle layer 10, and an inner layer 12. The inner layer 12 and the outer layer 8 are comprised of an elastomeric material such as neoprene rubber. The middle layer 10 is preferably comprised of Kevlar™ brand fabric.

Although the present invention is explained in terms of three (3) layers, this is not a limitation of the present invention but for exemplary purposes only. What is necessary for proper function of the invention disclosed herein is a tough, generally puncture-resistant barrier, as well as an air or fluid filled impermeable barrier. Accordingly, a Kevlar™ brand fabric layer and a neoprene type layer are required unless one single layer may be provided, having both characteristics in one layer.

In use, the product to be transported 40, FIG. 3, such as explosives or ammunition, would be placed in a standardized, reusable container 32, such as a truck, train or ship cargo hold, and surrounded by one or more of the packing component or bladders 10 of the present invention. The internal cavity of the bladder 10 would be inflated with air, gel or other similar liquid or viscous fluid by means of the valve 6 to ensure secure confinement for shipment. Once the shipment reaches its destination, the valve is used to release the viscous fluid to allow removal of the product 40 and re-use of the bladder 10. It is understood that more than one bladder may be utilized to confine and secure the product to be shipped.

Many variations for the materials used for the bladder are possible within the teachings of subject invention. The shape and the size of the bladder can also be varied without deviating from the teachings of subject invention.

In light of the above, it is therefore understood that within the scope of the appended claims, the invention may be practiced otherwise than as specifically described.

What is claimed is:

1. An inflatable bladder for use in package transport comprising:
an internal cavity;
an exterior wall; and
a valve penetrating said exterior wall, said exterior wall including at least one layer comprising a puncture-resistant material and a fluid medium as an impermeable material.

2. The bladder of claim 2 wherein said puncture resistant material is Kevlar™ brand fabric.

3. The bladder of claim 1 wherein said exterior wall comprises a multi-layered exterior wall comprising:
an outer layer;
a middle layer; and
an inner layer.

4. The bladder of claim 3 wherein said outer and inner layers comprise a neoprene material and said middle layer comprises a puncture resistant material.

5. An inflatable bladder for use in package transport comprising:
an exterior wall comprising a multi-layered exterior wall with an outer layer, a middle layer, and an inner layer, wherein said outer and inner layers comprise a neoprene material and said middle layer comprises a puncture resistant material.

6. The bladder of claim 5 wherein said puncture resistant material is Kevlar™ brand material.
